(19) United States
(12) Patent Application Publication
(10) Pub. No.: US 2020/0258075 A1
(43) Pub. Date: Aug. 13, 2020

(54) CLOSED LOOP MULTI-PARTY FEEDBACK

(71) Applicant: TipGenie, Inc., Mountain View, CA (US)

(72) Inventors: Ellalinda N. Rustique, Mountain View, CA (US); Amy Yoshitsu, Berkeley, CA (US); Bert Hebbert Castillo, San Francisco, CA (US); Benjamin Hochberg, Los Angeles, CA (US)

(73) Assignee: TipGenie, Inc., Mountain View, CA (US)

(21) Appl. No.: 16/789,386

(22) Filed: Feb. 12, 2020

Related U.S. Application Data
(60) Provisional application No. 62/804,691, filed on Feb. 12, 2019.

(51) Int. Cl. G06Q 20/32; G06Q 10/06; G06K 19/06

(52) U.S. Cl. CPC G06Q 20/3224; G06K 19/06037; G06Q 10/06398

(57) ABSTRACT

Providing closed loop multi-party feedback between a customer, an employee and an employer. In an embodiment, operational analytics are performed on obtained data and the results are displayed to the employer using graphical representations. In an embodiment, tipping management and distribution is provided.

### CROSS-REFERENCE TO RELATED APPLICATIONS

The present application claims priority to U.S. Provisional Patent Application Ser. No. 62/804,691, which is incorporated by reference.

### BRIEF DESCRIPTION OF THE DRAWINGS

FIG. 1 depicts a diagram of an example of a system for providing multi-party tip management and distribution for customers, employees, and employers.

FIG. 2 depicts a flowchart of an example of a method for closed loop multi-party tipping management and distribution between a customer, employee and employer.

FIG. 3 depicts a diagram of an example of a system for establishing and maintaining a closed loop between an employer, and employee, and a set of customers.

FIG. 4 depicts a flowchart of an example of a method for establishing and maintaining a closed loop between an employer, an employee, and a set of customers.

FIGS. 5A-D show example screenshots of a user interface used in accessing and managing accounts for providing closed loop multi-party tipping.

FIGS. 6A-C show various payment interfaces through which a customer can manage payment of tips as part of a closed loop multi-party tipping system.

FIGS. 7A-D show various customer interfaces through which a customer can manage their account as part of a closed loop multi-party tipping system.

FIGS. 8A-D show various customer interfaces through which a customer can identify an employee and provide a tip to an employee as part of a closed loop multi-party tipping system.

FIG. 9 shows a photograph of an example of a QR code physical display at a location.

FIGS. 10A-C show examples of splash screens through which a customer can leave a tip and/or provide feedback.

FIG. 11 shows an example of a customer receipt for a tip processed by a third-party digital payment system.

FIGS. 12A-C show various employee interfaces through which an employee can create and manage their account as part of a closed loop multi-party tipping system.

FIGS. 13A-C show various employee interfaces through which an employee can manage their account as part of a closed loop multi-party tipping system.

FIG. 14 shows an employee interface through which an employee can create and customize their account as part of a closed loop multi-party tipping system.

FIG. 15 shows an employee interface through which an employee can design a QR code physical display as part of a closed loop multi-party tipping system.

FIGS. 16A and 16B show employee interfaces through which an employee can manage their account as part of a closed loop multi-party tipping system.

FIGS. 17A-C show various employer interfaces through which an employer can manage its account as part of a closed loop multi-party system.

FIG. 18 shows a mobile employer interface through which an employer can manage its account as part of a closed loop multi-party system.

FIGS. 19A-C show example notifications in an embodiment where the closed loop multi-party system is linked with a third-party digital payment system that processes payments.

FIGS. 20A-F show various interfaces that display analytics data generated as part of a closed loop multi-party system.

### DETAILED DESCRIPTION

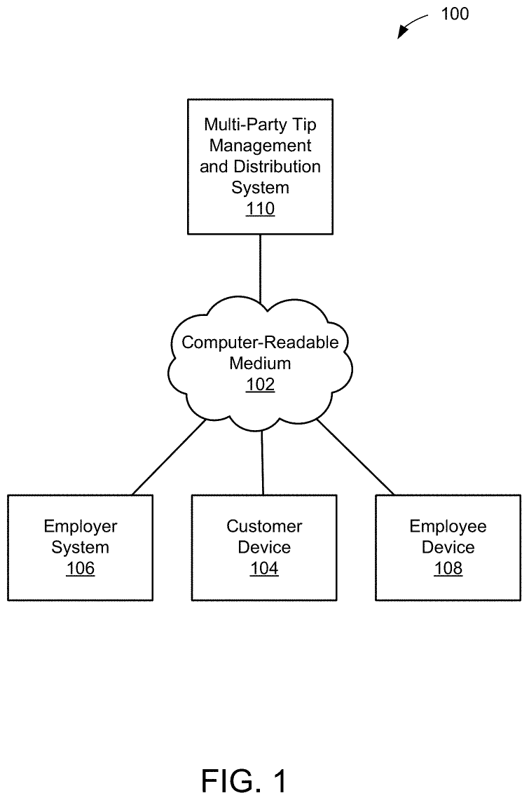

FIG. 1 depicts a diagram 100 of an example of a system for providing multi-party tip management and distribution for customers, employees, and employers. The system of the example of FIG. 1 includes a computer-readable medium 102, a customer device 104, an employer system 106, an employee device 108, and a multi-party tip management and distribution system 110.

In the example of FIG. 1, the computer-readable medium 102 couples the customer device 104, the employer system 106, the employee device 108, and the multi-party tip management and distribution system 110 together. As used in this paper, a “computer-readable medium” is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer-readable medium 102 is intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

The computer-readable medium 102, the customer device 104, the employer system 106, the employee device 108, the multi-party tip management and distribution system 110, and other applicable systems or devices described in this paper can be implemented as a computer system, a plurality of computer systems, or parts of a computer system or a plurality of computer systems. A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liqUID crystal display (LCD), or some other applicable known or convenient display device. The interface can include one or more of a modem or network interface. It will be appreciated that a modem or network interface can be considered a part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to client devices. The computing resources, software and/or information can be virtualized by maintaining centralized services and resources that the edge devices can access over a communication interface, such as a network. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their client device.

A computer system can be implemented as an engine, as part of an engine, or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a general- or specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself Many data structures use both principles, sometimes combined in non-trivial ways. The implementation of a data structure usually entails writing a set of procedures that create and manipulate instances of that structure. The datastores, described in this paper, can be cloud-based datastores. A cloud-based datastore is a datastore that is compatible with cloud-based computing systems and engines.

Returning to the example of FIG. 1, the customer device 104 functions to send and receive data used in providing multi-party tip management and distribution. Tip data regarding multi-party tip management and distribution includes applicable data related to providing tips to employees. As used in this paper, multi-party tip management and distribution includes provisioning of tips to specific employees of an employer, as part of a closed loop system. As used in this paper, a closed loop system is a system in which an employer, an employee, and a customer are all aware or become aware of tips being provided to an employee. For example, as part of closed loop multi-party tip management, messages can be sent to an employee and an employer indicating a tip that a customer is providing to the employee. Depending upon implementation-specific or other considerations, as part of a closed loop system, a tip can be sent directly to payroll of an employer, where the tip is processed and included as part of the pay of an employee without interference from an employer. For example, a guest at a hotel can provide a tip to a specific employee of the hotel when the guest pays its bill, after which the hotel can provide the tip to the specific employee. Further depending upon implementation-specific or other considerations, as part of a closed loop system, a tip can be sent directly to an employee and an employer can be informed of the tip. In various implementations, the customer device 104 is a mobile device. For example, the customer device 104 can be a thin client or an ultra-thin client.

Depending upon implementation-specific or other considerations, tip data can include feedback of a customer regarding an employee or an employer separate from a tip. For example, tip data can include a rating of an employee in providing services to a customer. In another example, tip data can include a rating of an employer in providing services to a customer. In another example, tip data can include responses to surveys, which may be employer-designed and thus provide an employer with customized and targeted feedback.

In a specific implementation, the customer device 104 includes functionalities for identifying employees in providing multi-party tip management and distribution. For example, the customer device 104 can include a graphic interface through which a customer can view identifications of employees that provided services to the customer. In various implementations, the customer device 104 can include a scanner/reader, e.g. a Quick Response (QR) code reader that can be used to scan a QR code that identifies an employee. For example, if a customer is staying in a hotel, a room can include a QR code unique to maids who clean the room, which the customer can scan with the customer device 104 to identify the maids and subsequently provide a tip as part of multi-party tip distribution using the customer device 104.

In a specific implementation, the customer device 104 functions to send and receive tip data that includes a rating of an employer. The customer device 104 can be used to send a rating or feedback of an employer. For example, if a customer is happy with employees at a hotel but is not happy with the accommodations of the hotel, the customer device 104 can be used to send tip data indicating negative feedback of the hotel.

The employer system 106 functions as an applicable system of in managing employees. The employer system 106 can include a payroll system of the employer that is used to disburse payment to an employee, either as part of regular pay, or tips accrued by the employee. The employer system 106 can include interfaces to devices used by managers. In various implementations, the interfaces can be used to transmit and receive tip data regarding closed loop multi-party tip management and distribution. For example, interfaces included as part of the employer system 106 can be used to transmit tip data regarding tips an employee has received. In various implementations, tip data can indicate employees to whom tips have been given as part of a closed loop system. For example, through the employer system 106, managers can view tips given to a specific employee as part of a closed loop system and/or an identification of customers who gave the tips. In various implementations, tip data can indicate feedback from customers regarding specific employees or employers. For example, through the employer system 106, managers can view feedback ratings given to specific employees by customers.

The employee device 108 functions as an applicable device through which a user can receive information as part of closed loop multi-party tip management and distribution. In various implementations, an employee can receive, at least a portion of, tip data included as part of closed loop multi-party tip management and distribution. For example, through the employee device 108, an employee can be alerted when they have been given a tip or positive feedback and can view the identity of a customer who provided the tip or positive feedback. In various implementations, an employee can view received payment included as part of a tip given in multi-party tip distribution. For example, an employee can view a bank account and a deposit made as part of a tip given in multi-party tip distribution.

The multi-party tip management and distribution system 110 functions to provide closed loop multi-party tip management and distribution. The multi-party tip management and distribution system 110 can be implemented as part of a native application or a web-based application that can be accessed through a web portal. In providing closed loop multi-party tip management and distribution, the multi-party tip management and distribution system 110 can send and receive tip data regarding closed loop multi-party tip management. In various implementations, the multi-party tip management and distribution system 110 can receive tip data from a customer device. Tip data received by the multi-party tip management and distribution system 110 from a customer device can include an amount of a tip to give to a specific employee. In various implementations, the multi-party tip management and distribution system 110 can send tip data to an employer system. For example, the multi-party tip management and distribution system 110 can send tip data indicating a tip amount an employee of an employer has received to a system of the employer. In various implementations, the multi-party tip management and distribution system 110 can send tip data to an employee device. For example, the multi-party tip management and distribution system 110 can send tip data indicating an amount of a tip an employee has received to a device of the employee.

In a specific implementation, the multi-party tip management and distribution system 110 can send provider data to a customer for use in generating tips. Provider data includes applicable information regarding an employee or an employer for use in giving tips and feedback. For example, provider data can include an identification of an employee and a rating of an employee. In another example, provider data can include an identification of an employer and a rating of an employer. In various implementations, a customer can use provider data to determine an identification of an employee who provided service and subsequently give a tip to or feedback for the employee based on the provider data.

In a specific implementation, the multi-party tip management and distribution system 110 functions to provision a tip to an employee as part of closed loop tip management based, at least in part, on received tip data. In various implementations, the multi-party tip management and distribution system 110 provides tip data to a payroll of an employee for distribution of a tip to an employee. In providing tip data to payroll, closed loop multi-party tip management can be achieved, as the employer is made aware of the tip given to an employee. Depending upon implementation-specific or other considerations, the multi-party tip management and distribution system 110 can be implemented as part of a payroll system of an employer or configured to communicate directly with payroll of an employer. In various implementations, the multi-party tip management and distribution system 110 functions to transfer a tip from a customer directly to an employee using an applicable digital payment system while also sending a message to an employer that the employee has been tipped. For example, the multi-party tip management and distribution system 110 can use Google Wallet®, Apple Pay®, Square®, Stripe®, or Pay Pal®, to transfer a tip to an employee.

In a specific implementation, the multi-party tip management and distribution system 110 functions to implement employer policies in providing closed loop multi-party tip management and distribution. Employer policies can include applicable rules and regulations for tip management within an organization of the employer. For example, employer policies can specify that an employee is only allowed to receive a certain amount of tip. In another example, employer policies can specify that tips given to an employee are to be split up between employees within a team. In yet another example, employer policies can specify that an employee is entitled to a percentage of given tips based on their rating provided by customers. In implementing employee policies in providing multi-party tip management and distribution, the multi-party tip management and distribution system 110 can manage an amount of tip owed to specific employees based on tips received by employees. For example, the multi-party tip management and distribution system 110 can determine that all employees on a team are entitled to specific tip amounts and subsequently distribute or send tip data to cause distribution of the specific tip amount to the employees.

In a specific implementation, the multi-party tip management and distribution system 110 functions to ensure accountability of an employee in distributing tips as part of closed loop multi-party tip management and distribution. Specifically, the multi-party tip management and distribution system 110 can check to make sure that appropriate tips are being distributed to employees by an employer. In various implementations, the multi-party tip management and distribution system 110 can maintain records of tip data indicating correct tip amount and employees to which the correct tip amounts should be distributed. Further in various implementations, the multi-party tip management and distribution system 110 can check its maintained records with records of payrolls of employers to ensure appropriate tips are being distributed to employees by the employers.

In a specific implementation, the multi-party tip management and distribution system 110 functions to verify tip data received from a customer in providing closed loop multi-party tip management and distribution. In verifying tip data, the multi-party tip management and distribution system 110 can verify that an employee, who is given a tip, as indicated by the tip data, is actually an employee with an employer. For example, the multi-party tip management and distribution system 110 can look up records indicating employees of an employer to verify that a person who is given a tip, is actually an employee of an employer. Further, in verifying tip data, the multi-party tip management and distribution system 110 can verify that an employee who is given a tip is actually a person who performed services for a customer. For example, if tip data indicates that a customer has given a tip to an employee for providing maid services, but the employee is actually a front desk employee, then the multi-party tip management and distribution system 110 can determine that the customer has made a mistake. In another example, if tip data indicates that a customer has given a tip to an employee, but location data of the employee indicates that the employee never actually gave service to the customer, then the multi-party tip management and distribution system 110 can determine that the customer has made a mistake. A location of an employee can be determined through geolocation using a device of the employee.

In a specific implementation, the multi-party tip management and distribution system 110 functions to provide remedial actions when tip data is invalid. In various implementations, the multi-party tip management and distribution system 110 can provide notification to either or both an employer and a customer when tip data is invalid. For example, the multi-party tip management and distribution system 110 can send a message to a customer informing them that they have tipped or given feedback for the wrong employee. Further in the example, the multi-party tip management and distribution system 110 can suggest to the customer an appropriate employee to tip.

In a specific implementation, the multi-party tip management and distribution system 110 functions to provide feedback given by customers, indicated by tip data, to either or both an employer and an employee. In various implementations, the multi-party tip management and distribution system 110 can provide feedback given by customers to an employer. For example, the multi-party tip management and distribution system 110 can provide feedback given by a customer for an employee to an employer. In another example, the multi-party tip management and distribution system 110 can provide feedback given by a customer for an employer to the employer. In various implementations, the multi-party tip management and distribution system 110 can provide feedback given by customers to an employee. For example, the multi-party tip management and distribution system 110 can send a message to an employee indicating the employee has been given positive feedback from a customer.

In a specific implementation, the multi-party tip management and distribution system 110 can utilize emotional analytics in determining or modifying tip data. Emotional analytics can be based on an analysis of interactions of a customer with the multi-party tip management and distribution system 110. Example interactions, to which emotional analytics are applied, can include a way that a customer speaks and messages customer inputs. For example, the multi-party tip management and distribution system 110 can determine that a customer is not happy based on a tone of the customer's voice and subsequently modify a tip amount or a rating based on the tone of the customer's voice. In another example, the multi-party tip management and distribution system 110 can determine that a customer is happy based on the messages they provide as feedback and subsequently modify a tip amount or a rating based on the messages.

In a specific implementation, the multi-party tip management and distribution system 110 determines analytics based on tip data received from customers. As used in this paper, analytics includes applicable data related to giving of tips and feedback for employees and employers by customers. For example, analytics can include amount of tips customers are giving, employees to whom customers are giving tips and amount given in tips, feedback customers are giving, feedback employees or employers are receiving, tips and feedback received by departments or groups of employees, which customers are giving tips or feedback, geographic, behavioral, psychographic, and demographic variables of customers giving tips or feedback and/or of employees receiving tips or feedback. The multi-party tip management and distribution system 110 can determine analytics based on tip data received from any one of a customer, an employer, and an employee. For example, the multi-party tip management and distribution system 110 can determine an amount of tips given to a specific employee based on tip data received from customers giving tips to the specific employee. In various implementations, the multi-party tip management and distribution system 110 can provide determined analytics to an employer and/or an employee

In a specific implementation, the multi-party tip management and distribution system 110 can manage an account of a customer in providing closed loop multi-party tip management and distribution. In managing an account of a customer, the multi-party tip management and distribution system 110 can verify and login a customer for providing tips or feedback as part of closed loop multi-party tip management. In various implementations, the multi-party tip management and distribution system 110 can keep a record of tips and feedback given by a customer to employees and employers. For example, the multi-party tip management and distribution system 110 can keep a record of transactions made by a customer in providing tips and provide data showing the transactions made by the customer.

In a specific implementation, the multi-party tip management and distribution system 110 can advise a party in providing tip data. In various implementations, the multi-party tip management and distribution system 110 can advise or suggest an amount for a customer to tip. The multi-party tip management and distribution system 110 can advise or suggest an amount for a customer to tip based on local tipping customs and/or past tipping behaviors of the customer. For example, if a customer previously tipped 10 dollars to a bellhop at a hotel, then the multi-party tip management and distribution system 110 can suggest that the customer tip 10 dollars to another bellhop. In another example, if it a local tipping custom is to tip 10%, then the multi-party tip management and distribution system 110 can recommend to the customer that they tip 10%.

In a specific implementation, the multi-party tip management and distribution system 110 functions to accept and store payment information from a customer. Payment information includes applicable information used in provisioning tips from a customer to an employee as part of a closed loop system. For example, payment information can include credit card information of a customer utilized in paying a given tip. In another example, payment information can include a digital payment system to use, e.g. Apple Pay®, in paying a given tip.

In a specific implementation, the multi-party tip management and distribution system 110 can manage an account of an employee related to closed loop multi-party tip management and distribution. In various implementations, in managing an account of an employee, the multi-party tip management and distribution system 110 can maintain records of tips and feedback received by an employee. For example, the multi-party tip management and distribution system 110 can show an employee all of the tips that they have earned over the past week. In various implementations, in managing accounts of an employee, the multi-party tip management and distribution system 110 can alert an employee when they have received a tip or feedback. For example, if a customer leaves feedback for an employee, as indicated by tip data, then the multi-party tip management and distribution system 110 can alert the employee that they have received feedback.

In a specific implementation, the multi-party tip management and distribution system 110 can manage payment of an employee's tips as part of closed loop multi-party tip management. In managing payment of an employee's tips, the multi-party tip management and distribution system 110 can receive payment information of an employee. Payment information of an employee can include applicable information related to transferring money to an employee, for example, payment information of an employee can include an account of the employee in which to deposit tip money. In various implementations, the multi-party tip management and distribution system 110 can use payment information of an employee to provision payment of tips to the employee. For example, the multi-party tip management and distribution system 110 can use payment information indicating an account of an employee to transfer money earned as tips to the employee.

In a specific implementation, the multi-party tip management and distribution system 110 can manage an account of an employer. In managing an account of an employer, the multi-party tip management and distribution system 110 can alert an employer when an employee has been given a tip. In various implementations, in managing an account of an employer, the multi-party tip management and distribution system 110 can maintain records of tips and feedback received by an employer or employees of the employer. For example, the multi-party tip management and distribution system 110 can show an employer all of the feedback that has been received for the employer over the past week. In various implementations, in managing accounts of an employer, the multi-party tip management and distribution system 110 can alert an employer when they have received feedback. For example, if a customer leaves feedback for an employee, as indicated by tip data, then the multi-party tip management and distribution system 110 can alert the employer that they have received feedback. In various implementations, in managing an account of an employer, the multi-party tip management and distribution system 110 can manage or update policies of the employer. The multi-party tip management and distribution system 110 can update or generate employer policies based on input received from the employer. For example, the multi-party tip management and distribution system 110 can change an employer policy from “an employee has to share 10% of their tips with their team” to “an employee has to share 15% of their tips with their team” based on input received from the employer.

In a specific implementation, the multi-party tip management and distribution system 110 functions to provide rewards to a customer for providing tips and/or feedback as part of closed loop multi-party tip management. In various implementations, the multi-party tip management and distribution system 110 can manage a rewards system for customers as part of closed loop multi-party tip management. For example, the multi-party tip management and distribution system 110 can provide a reward to a customer every time the customer leaves feedback or after a specific number of times a customer has left feedback.

In an example of operation of the example system shown in FIG. 1, the customer device 104 provides tip data of an employee provided service. In the example of operation of the example system shown in FIG. 1, the multi-party tip management and distribution system 110 provisions a tip to the employee as part of a closed loop according to the tip data. Further, in the example of operation of the example system shown in FIG. 1, the multi-party tip management distribution system 110 sends notification of the tip provisioned to the employee to the employer through the employer system 106 and to the employee through the employee device 108.

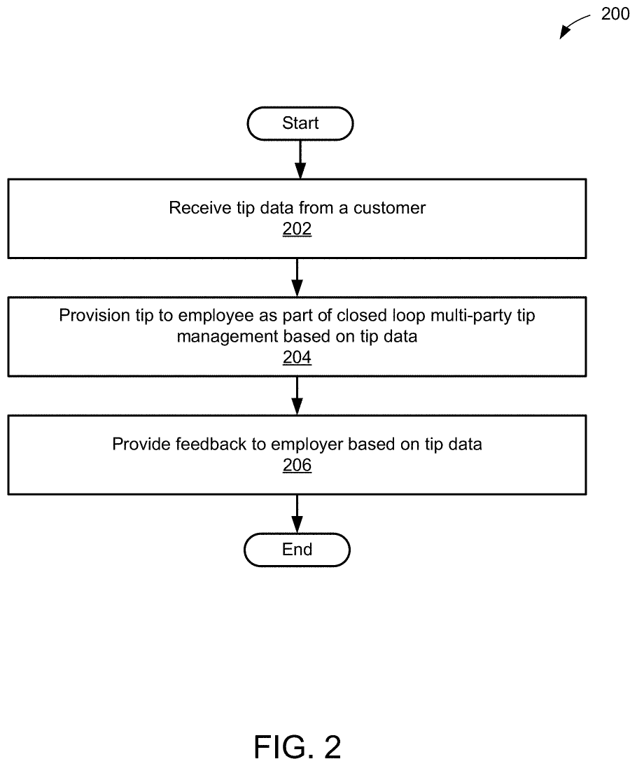

FIG. 2 depicts a flowchart 200 of an example of a method for closed loop multi-party tipping management and distribution between a customer, employee and employer. The flowchart 200 begins at module 202, where tip data is received from a customer. Tip data can be received through an applicable system, such as the multi-party tip management and distribution systems described in this paper. Tip data can include an identification of an employee to tip, an amount to tip, and feedback of either or both an employer and the employee.

The flowchart 200 continues to module 204, where a tip is provisioned to an employee as part of closed loop multi-party tip management and distribution, based on the tip data. An applicable system for provisioning a tip as part of closed loop multi-party tip management and distribution, such as the multi-party tip management and distribution systems described in this paper, can provision a tip as part of closed loop multi-party tip management and distribution, according to the tip data. Depending upon implementation-specific or other considerations, as part of a closed loop, a tip amount to tip an employee can be sent directly to a payroll of an employer, which can then process and pay the tip to the employee. Further depending upon implementation-specific or other considerations, as part of a closed loop, a tip amount to tip an employee can be directly transferred to the employee and an employer can be notified of the payment of the tip.

The flowchart 200 continues to module 206, where feedback is provided to an employer based on the tip data. An applicable system for providing feedback based on tip data, such as the multi-party tip management and distribution systems described in this paper, can provide feedback to an employer based on the tip data. Depending upon implementation-specific or other considerations, feedback provided to the employer based on tip data can include feedback regarding the employer and/or feedback regarding the employee. For example, feedback can include a rating that the customer gave the employer.

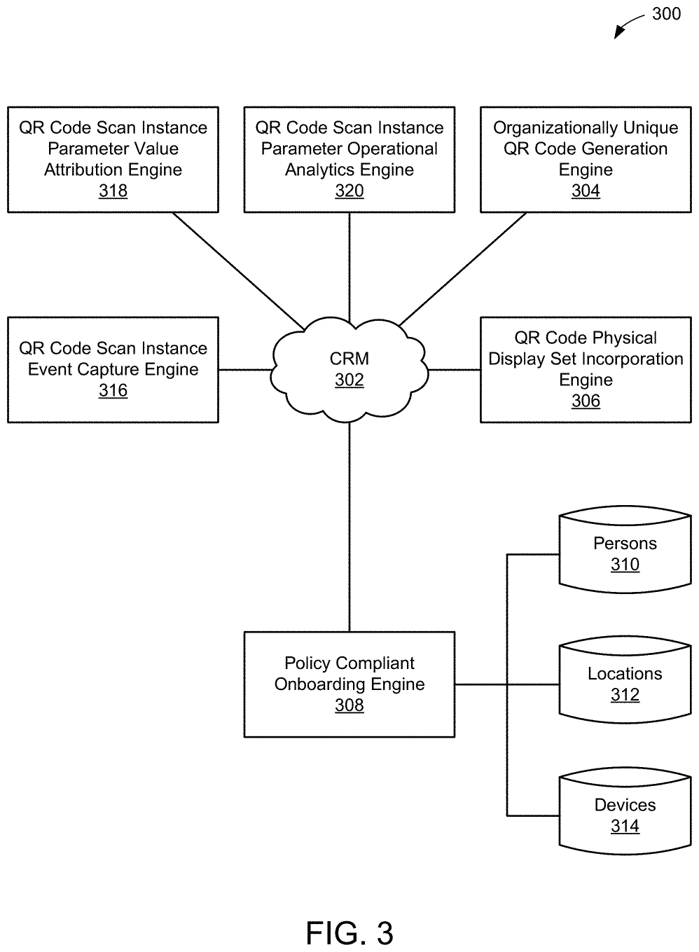

FIG. 3 depicts a diagram 300 of an example of a system for establishing and maintaining a closed loop between an employer, an employee, and a set of customers. In the example of FIG. 3, the computer-readable medium 302 couples the organizationally unique QR code generation engine 304, the QR code physical display set incorporation engine 306, the policy compliant onboarding engine 308, the QR code scan instance event capture engine 316, the QR code scan instance parameter value attribution engine 318, and the QR code scan instance parameter operational analytics engine 320 together. Policy compliant onboarding engine 308 is coupled to persons datastore 310, locations datastore 312, and devices datastore 314.

The organizationally unique QR code generation engine 304 is intended to represent an engine that generates QR codes for organizations. Each QR code is uniquely associated with an organizationally unique identifier. Developing a QR code can include QR code design (e.g., if applicable, to include a logo, relevant color, or other functional or aesthetic aspects of QR codes that will be used by the organization) at least includes generating a QR code for a person, place, or device. For example, a QR code can be associated with a UID of a human or artificial agent of the organization, a human or artificial agent of another organization, an independent contractor, a guest, or some other entity. Instead or in addition, a QR code can be associated with a UID of a location that can be associated with one or more individuals, such as a QR code for a station within an organization, such as a help desk, a valet station, a room, or the like. Instead or in addition, a QR code can be associated with a UID of a device that can be associated with one or more individuals, such as furniture, a cart, an automobile, or the like. Organizationally appropriate (i.e., QR codes that meet the design criteria for the organization) QR codes can be generated in association with a UID or for later association therewith (e.g., when assigned to an employee, deployed to a location, or affixed to a device).

The QR code physical display set incorporation engine 306 is intended to represent an engine that incorporates QR codes into a set of physical QR code displays. In a specific implementation, the set of physical QR code displays consists of a single physical QR code display per unique QR code. In such an implementation, each physical QR code display is uniquely associated with an employee, a location, or a device when generated (see module 402). Instead or in addition, a physical QR code display can be uniquely associated with an employee, a location, or a device when issued or deployed, either explicitly or as determined with business intelligence, such as employee work schedules, driver check-in, location-tracking correlation, or the like. Particularly where business intelligence is reliable, the set of physical QR code displays can be a plurality, but is also acceptable where pooling is appropriate (e.g., if tips are shared between all waitresses, each waitress on the floor need not have a unique physical QR code display). In an alternative, the physical QR code display includes an electronic display, such as a smartphone display. In such an implementation, incorporating the QR code into the physical QR code display entails electronic or optical (e.g., via camera) transmission of the QR code to an electronic device, which at some time subsequent displays the QR code on an electronic display of the electronic device or a peripheral. In an implementation in which a QR code is associated with a UID, the set of physical QR code displays can be characterized as associated with a UID, as well.

The policy compliant onboarding engine 308 is intended to represent an engine that onboards a person, location, or device in association with at least one QR code display of a set of physical code displays. In a specific implementation, the policy compliant onboarding engine 308 obtains an organizationally unique QR code, the UID associated with an organizationally unique QR code, or both, or uniquely matches an organizationally unique UID to the organizationally unique QR code when a physical QR code display incorporating the QR code is issued to an employee, deployed at a location, or affixed to a device. In a specific implementation, a physical QR code display associated with a UID includes a nametag in which the QR code is incorporated; the QR code is scanned when it is incorporated into a nametag associated with a particular employee and/or when the nametag is issued to a particular employee. In a specific implementation, a physical QR code display associated with a UID includes signage; the QR code is scanned when it is incorporated into a sign associated with a particular location and/or when the sign is deployed to a particular location. In a specific implementation, a physical QR code display associated with a UID includes a sticker with the QR code imprinted thereon; the QR code is scanned when the sticker is issued to a particular person or device and/or when the sticker is affixed to a nametag, plaque, or device. In some instances, a QR code may be repurposed but it is generally not difficult to generate new QR codes.

The QR code scan instance event capture engine 316 is intended to represent an engine that captures events in association with QR code scan instances. In a specific implementation, the QR code scan instance event capture engine 316 captures a QR code scan instance when a QR code is followed to a destination address identifiable from the QR code by a third party (e.g., a person outside of a closed loop of human and artificial agents of an organization) using a QR code scanning agent to scan the QR code. For example, a QR code scanning agent may use a camera to capture an image of the QR code, which is decoded to identify a destination address and a web browser agent may access a web page identifiable by the destination address. In this implementation, at the web-based location, the third party enters applicable parameter values, which can include a monetary amount, feedback in narrative and/or numerical (e.g., one-to-ten or number of stars), description of goods or services, pictures taken at the location, or the like. In an implementation in which a customer is providing a tip, the goods and services can be assumed (and either not made a part of the transaction record or incorporated into the transaction record without modification by the third party). In an implementation in which a customer is memorializing an event, it may be desirable to allow entry of an event description (e.g., a birthday party for Johnny Appleseed). Advantageously, the web-based approach, combined with the use of QR codes has been found to reduce transactional friction, which increases utilization by third parties.

Where the QR code is uniquely associated with an individual, such as when the QR code is unique and is incorporated into a nametag for an employee, the event record can be uniquely associated with the individual. Where the QR code is incorporated into signage or is otherwise not uniquely associated with a single individual at the time of issuance or onboarding, other operational intelligence (e.g., checking employee work schedules) can be used to determine an employee is uniquely associated with the QR code at a given time. For example, when a QR code is scanned (a “QR code scan instance”) by an electronic device that includes a camera, an event record may be generated shortly after the QR code is scanned (e.g., a person who wishes to give a valet a tip scans the QR code at the valet station, inputs a tip amount, indicates a satisfaction amount, and submits), which makes it possible to determine an employee (or group of employees) that can be uniquely associated with the QR code scan instance. In some instances, an event record is generated later (e.g., a person who wishes to provide feedback scans the QR code at the valet station and, a few hours later when they get back home, provides feedback in narrative form), which can be handled so long as the QR code scan instance has an associated timestamp. As such, a QR code that is not always uniquely associated with an individual can be uniquely associated with an individual (or group of individuals) for a timespan and a QR code that is uniquely associated with an individual (either explicitly or through the use of business intelligence) can be correlated to a QR code scan instance with a timestamp.

The QR code scan instance parameter value attribution engine 318 is intended to represent an engine that uses operational intelligence to associate event parameter values of an event record with a unique identifier (UID). In a specific implementation, the QR code scan instance parameter value attribution engine 318 matches an event record to an employee who is not explicitly identified in the event record. Depending upon the amount of operational intelligence available and security desired, confirmation can be augmented with face recognition technology at the locus of the QR code scan instance or flow of traffic toward or away from the locus, correlation with employee schedule, correlation with third party schedule, and/or GPS, RFID, or some other location-tracking technology, to name several. Advantageously, an employer agent can use the event record to visually confirm the parties to a transaction. The QR code scan instance parameter value attribution engine 318 is indicated to be optional because in some instances a QR code is unique to an individual so there is no need to use operational intelligence to determine the UID.

In a specific implementation, the QR code scan instance parameter operational analytics engine 320 uses operational intelligence to apportion a monetary amount of an event parameter value of an event record to one or more parties associated with the event record. For example, a monetary amount of an event parameter value of the event record associated with a QR code scan instance can be attributed to (and divided between, if applicable) a uniquely identified employee, an administrative organization, a transaction processing organization, or an employer. As other examples, feedback can be attributed to the third party provider of the event record in order to reward the third party, keep records of third party activity, evaluate general satisfaction within certain sub-locations of a location under the control of an organization, or the like; feedback can be attributed to a uniquely identified employee to evaluate the employee, enable the employee to see the feedback and learn from the experience, or the like; or; or the like. QR code scan instance parameter values can also be attributed to a group or division and allocated in accordance with predetermined rules or on an ad hoc basis. For example, waitresses on a floor may pool tips, which would result in a monetary amount of the event record being attributed at least in part to the tip pool. As another example, a delivery truck driver could scan a QR code at a delivery location to indicate a delivery has been received without designating a specific employee to receive the delivery.

The QR code scan instance parameter operational analytics engine 320 is intended to represent an engine that uses operational intelligence to manage parameter values of event records. In a specific implementation, the QR code scan instance parameter operational analytics engine 320 provides a map of activity for certain types of events. For example, if maids receive more tips on the 12^{th} floor of the west wing of a hotel, it may be useful to understand why that happens and perhaps raise prices in that wing due to greater perceived value, promote maids in the location, offer coupons for other locations of the hotel. Instead or in addition, the event record can be used to perform transactional, predictive, or performance analytics.

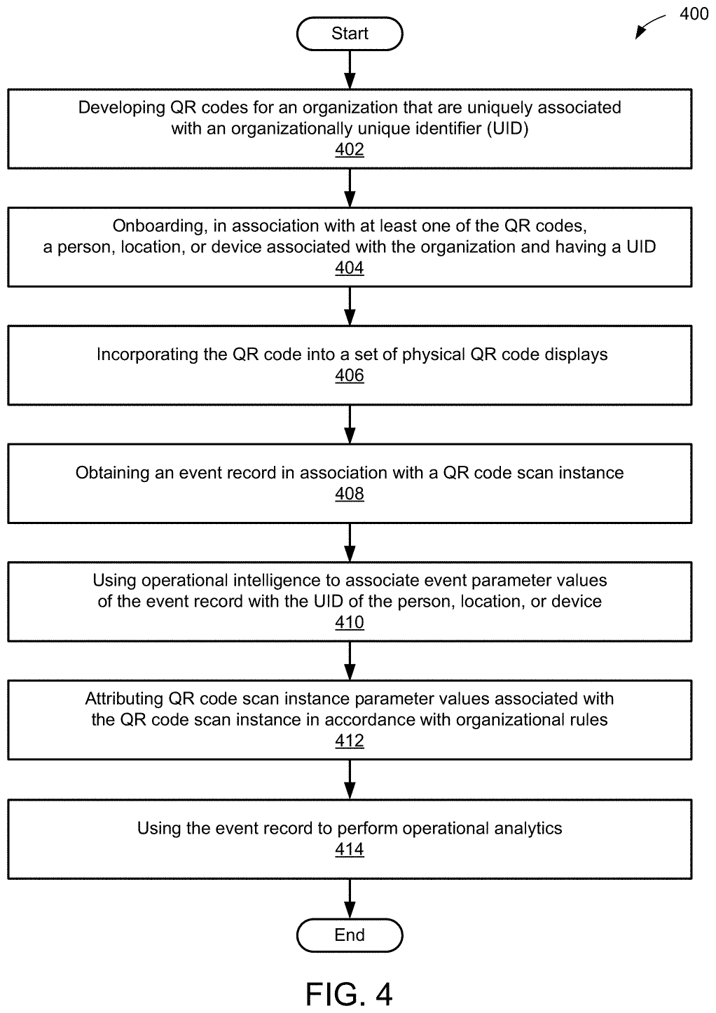

FIG. 4 depicts a flowchart 400 of an example of a method for establishing and maintaining a closed loop between an organization, an agent of the organization, and a third party. Advantageously, employers can ensure employees only obtain such QR codes from them, which enables the employer to perform operational, predictive, transactional, and performance analytics with some assurance that no relevant data is missing.

The flowchart 400 starts at module 402 with developing a QR code for an organization that is uniquely associated with an organizationally unique identifier (UID). In a specific implementation, the module 402 is carried out by an organizationally unique QR code generation engine, such as the organizationally unique QR code generation engine 304 of FIG. 3.

The flowchart 400 continues to module 404 with onboarding in association with at least one QR code display of the set of physical QR code displays a person, location, or device with a UID. In a specific implementation, the module 404 is carried out by a policy compliant onboarding engine, such as the policy compliant onboarding engine 308 of FIG. 3.

The flowchart 400 continues to module 406 with incorporating the QR code into a set of physical QR code displays. In a specific implementation, the module 406 is carried out by a QR code physical display set incorporation engine, such as the QR code physical display set incorporation engine 306 of FIG. 3.

The flowchart 400 continues to module 408 with obtaining an event record in association with a QR code scan instance. In a specific implementation, the module 408 is carried out by a QR code scan instance event capture engine, such as the QR code scan instance event capture engine 316 of FIG. 3.

The flowchart 400 continues to optional module 410 with using operational intelligence to associate event parameter values of the event record with a UID. In a specific implementation, the module 410 is carried out by a QR code scan instance parameter value attribution engine, such as the QR code scan instance parameter value attribution engine 318 of FIG. 3.

The flowchart 400 continues to module 412 with attributing QR code scan instance parameter values associated with the QR code scan instance in accordance with organizational rules. In a specific implementation, the module 412 is carried out by a QR code scan instance parameter value attribution engine, such as the QR code scan instance parameter value attribution engine 318 of FIG. 3.

The flowchart 400 continues to module 414 using the event record to perform operational analytics. In a specific implementation, the module 414 is carried out by a QR code scan instance parameter operational analytics engine, such as the QR code scan instance parameter operational analytics engine 320 of FIG. 3.

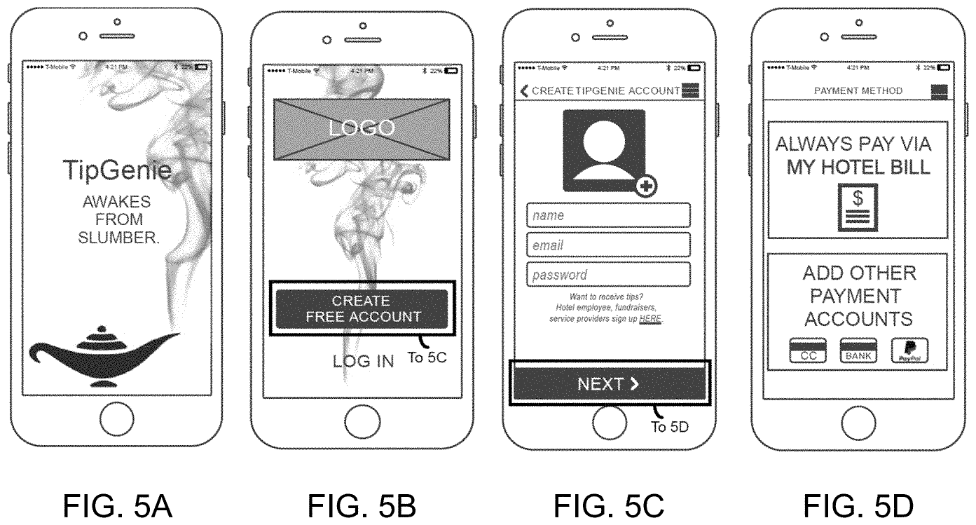

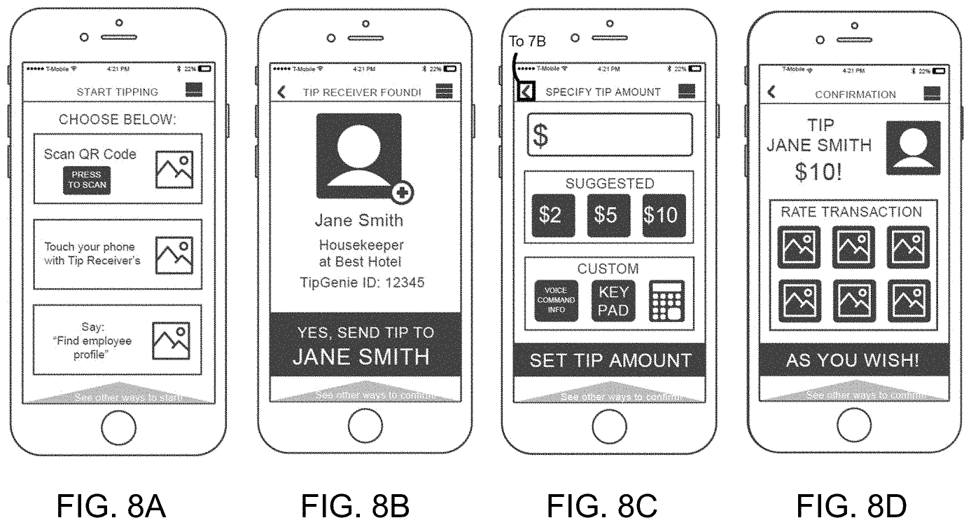

FIGS. 5A-D depict example screenshots of a user interface used in accessing and managing accounts for providing closed loop multi-party tipping. FIG. 5A shows an example welcome screen, and FIG. 5B shows an example login interface. The login interface includes a create account button and a login button. The create account button can be used to create a free account and when activated proceeds to the interface shown in FIG. 5C. The login button can be used to access an account of a user and when activated proceeds to the interface shown in FIG. 8A.

FIG. 5C shows a create account interface. The create account interface includes user information fields in which a user can input information utilized in creating an account. For example, the create account interface includes fields in which a user can input their name, their email, and their password. The create account interface includes a button that when activated proceeds to the payment information interface shown in FIG. 5D.

FIG. 5D shows a payment information interface where a user can input payment information. The payment information interface includes a first payment button and a second payment button. The first payment button, when activated, causes a closed loop multi-party tipping system to include tips as part of a bill from an employer. For example, the first payment button, when activated, causes tips to be added onto a hotel bill. The second payment button, when activated, allows a user to input payment methods for provisioning tips to employees.

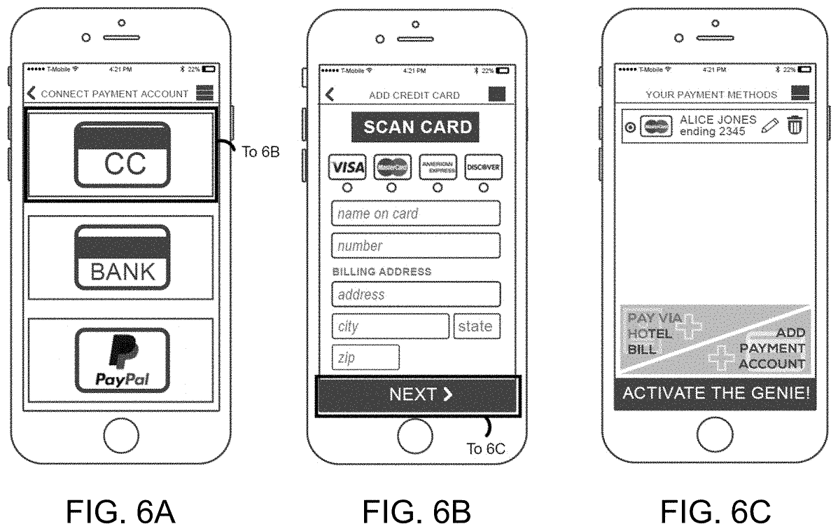

FIGS. 6A-C show various payment interfaces through which a customer can manage payment of tips as part of a closed loop multi-party tipping system. FIG. 6A shows a payment interface for selecting a method of payment. The payment interface includes a plurality of buttons corresponding to various payment methods. When these buttons are activated, a customer can input data used in the payment of tips according to the various payment methods.

FIG. 6B shows a payment interface through which a customer can input payment information related to credit card payment. The payment interface includes fields that can be populated with information, e.g. a customer's address, used in verifying payment through a credit card. The payment interface also includes fields to indicate a credit card type of a customer.

FIG. 6C shows a payment interface through which a customer can control payment methods. The payment interface includes a selectable list of previously entered payment methods of the customer. The payment interface also includes a button, that when activated, allows a user to input more payment methods.

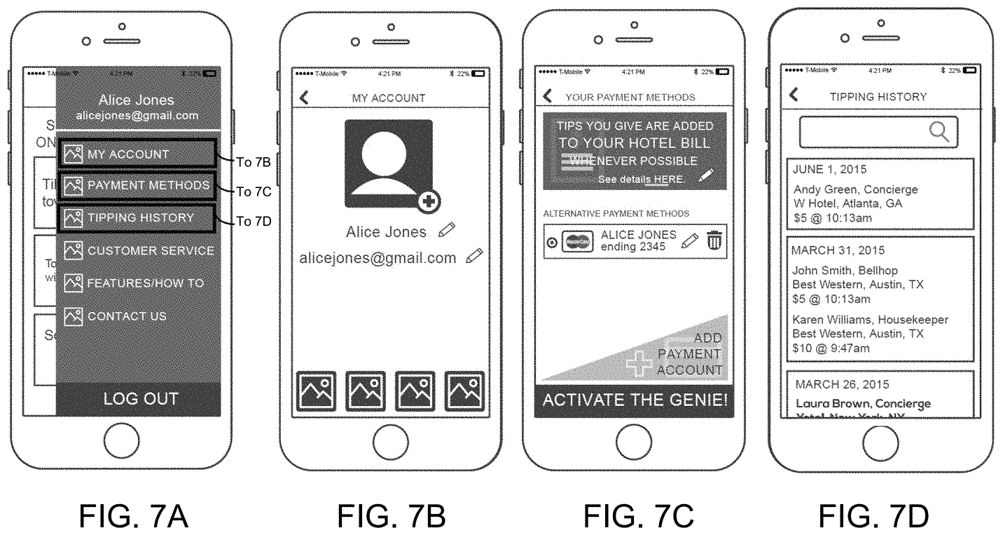

FIGS. 7A-D show various customer interfaces through which a customer can manage their account as part of a closed loop multi-party tipping system. FIG. 7A shows a customer interface through which a customer is given a broad overview of the account. The customer interface includes a my account button, a payment method button, and a tipping history button. When the my account button is activated, a customer is taken to an interface through which the customer can edit their account information. When the payment method button is activated, the customer is taken to an interface through which the customer can manage their payment method information. When the tipping history button is activated, the customer is taken to an interface through which the customer can view their tipping history. FIG. 7B shows a customer interface through which a customer can edit their account information. FIG. 7C shows a customer interface through which a customer can edit their payment information. FIG. 7D shows a customer interface through which a customer can view their tipping history.

FIGS. 8A-D show various customer interfaces through which a customer can identify an employee and provide a tip to an employee as part of a closed loop multi-party tipping system. FIG. 8A shows a customer interface through which a customer can identify an employee. The customer interface includes a first button that, when activated, causes a customer device to scan a QR code for identifying an employee. The customer interface also includes a button that, when activated, causes a customer device to exchange information with an employee device locally, for identifying an employee. Further, the customer interface includes a button that, when activated, asks for the customer device to receive provider information for identifying an employee.

FIG. 8B shows a customer interface through which a customer can verify to give a tip to an identified employee. The customer interface includes a display of an identification of an employee. The customer interface also includes a button that, when activated, verifies that the customer wants to provide a tip to the employee.

FIG. 8C shows a customer interface through which a customer can give a tip to an employee. The customer interface includes suggested tip amounts, a calculator button, a keypad button and a voice command button. When the calculator button is activated, a calculator interface appears through which a customer can calculate a tip amount. When the keypad button is activated, a keypad appears, through which a customer can submit comments or feedback. When the voice command button is activates, a microphone on a customer device can be activated and used to input voice commands. For example, a customer can say “tip ten dollars,” and the system can input 10 dollars as a tip amount.

FIG. 8D shows a customer interface through which a customer can leave feedback. The customer interface can appear after a customer has given a tip to an employee. The customer interface can include buttons that allow a customer to leave a rating as feedback.

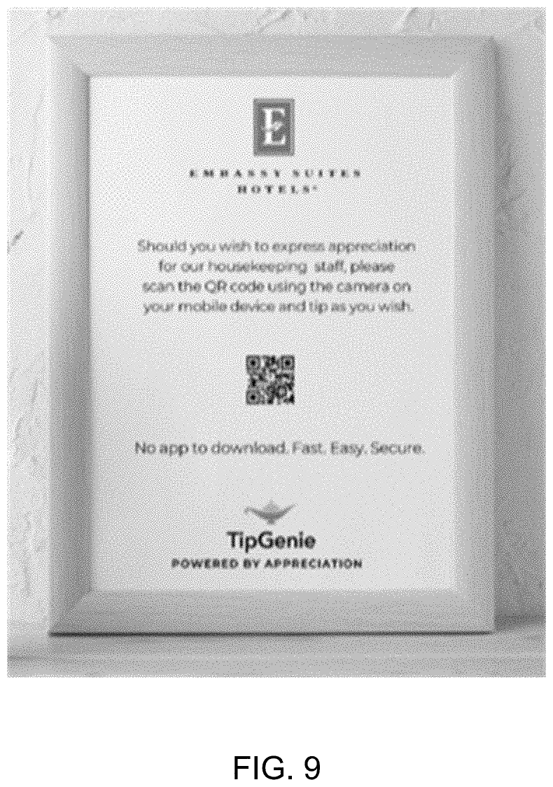

FIG. 9 shows a photograph of an example of a QR code physical display at a location. The QR code physical display includes an organizationally unique QR code. Advantageously, a customer can scan to provide a tip to an employee or team of employees as part of a closed loop multi-party tipping system.

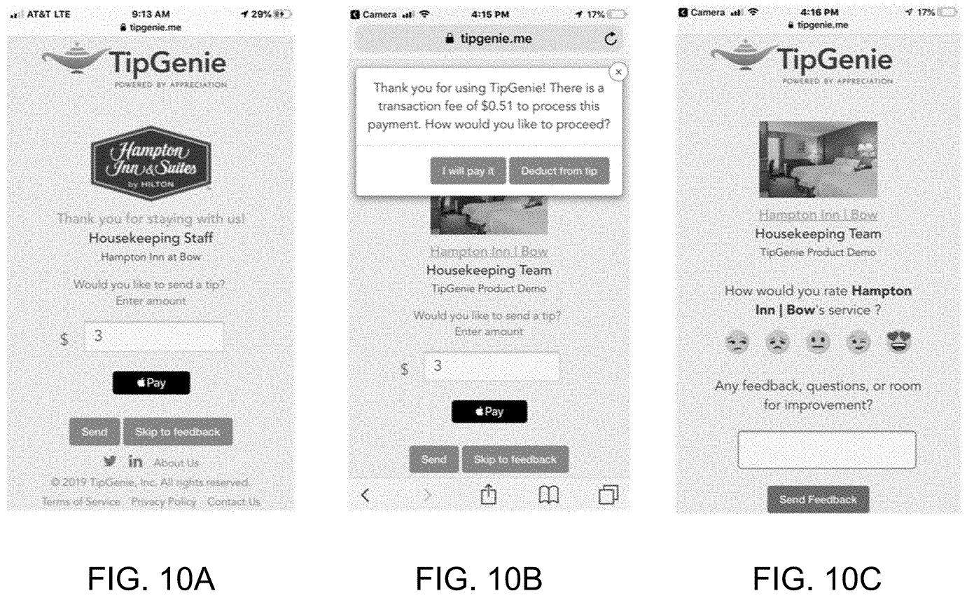

FIGS. 10A-C show examples of splash screens through which a customer can leave a tip and/or provide feedback. The splash screens are representative of various customer interfaces through which a customer can provide a tip and rate customer service as part of a closed loop multi-party feedback system.

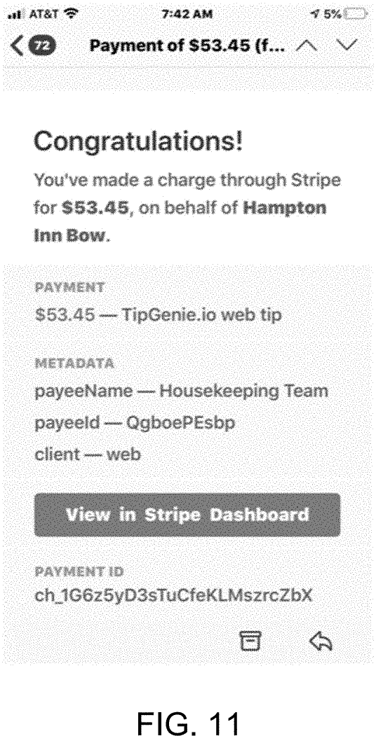

FIG. 11 shows an example of a customer receipt for a tip processed by a third-party digital payment system. For illustrative purposes in this example only, the third party digital payment system is Stripe.

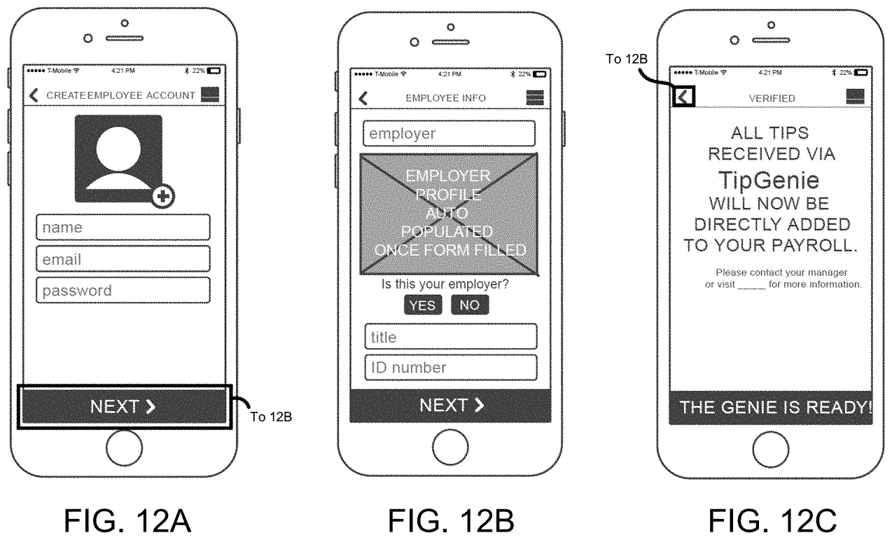

FIGS. 12A-C show various employee interfaces through which an employee can manage an account as part of a closed loop multi-party tipping system. FIG. 12A shows an employee interface through which an employee can access their account of a closed loop multi-party tipping system. The employee interface includes fields in which an employee can input their credentials.

FIG. 12B shows an employee interface through which an employee can identify their employer. The interface includes a button that when activated, indicates that the employer is verified. The employee interface also includes fields through which an employee can input their job title and their employee identification.

FIG. 12C shows an employee interface verifying that an employee will receive tips through a payroll of their employee. The employee interface can be presented to an employee after they have been verified as being an employee of the employer.

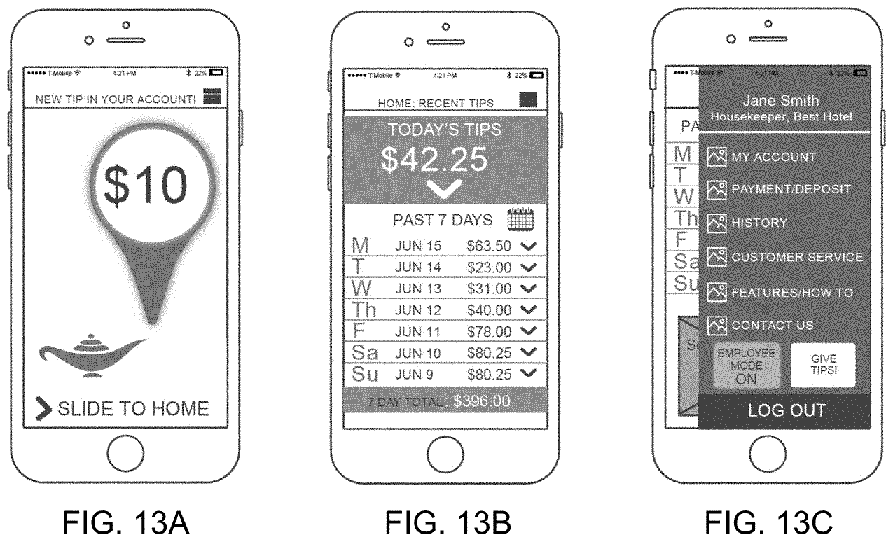

FIGS. 13A-C show various employee interfaces through which an employee can manage their account as part of a closed loop multi-party tipping system. FIG. 13A shows an interface that is presented to an employee when an employee receives a new tip. FIG. 13B shows an interface detailing a history of tips received by an employee. FIG. 13C shows an account management interface of an employee. The account management interface includes buttons that when activated allow an employee to switch from an employee to a customer, and subsequently be allowed to tip when utilizing a closed loop multi-party tipping system.

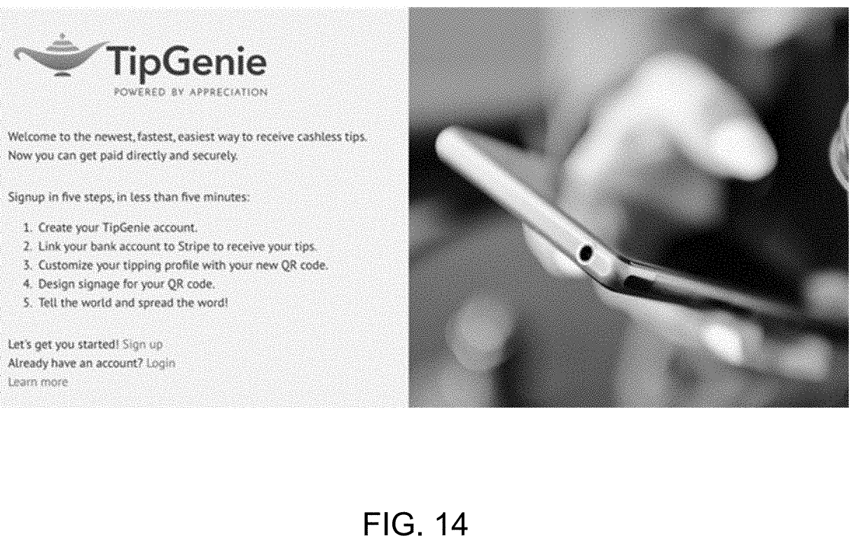

FIG. 14 shows an employee interface through which an employee can create and customize their account as part of a closed loop multi-party tipping system. Using the interface, the employee can link a bank account to their account, customize a tipping profile using a QR code, and design a QR code physical display. Depending on tip distribution policies of an employer of the employee, the QR code can be uniquely associated with the employee, uniquely associated with the employer, or uniquely associated with a group within the employer (e.g., housekeeping team).

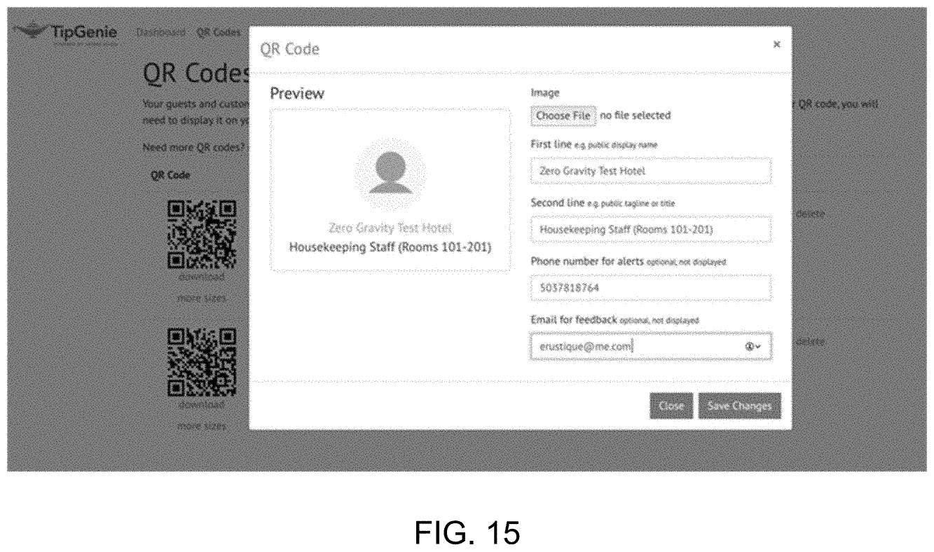

FIG. 15 shows an employee interface through which an employee can design a QR code physical display as part of a closed loop multi-party tipping system. The employee can also use the interface to configure settings for receiving optional alerts and feedback.

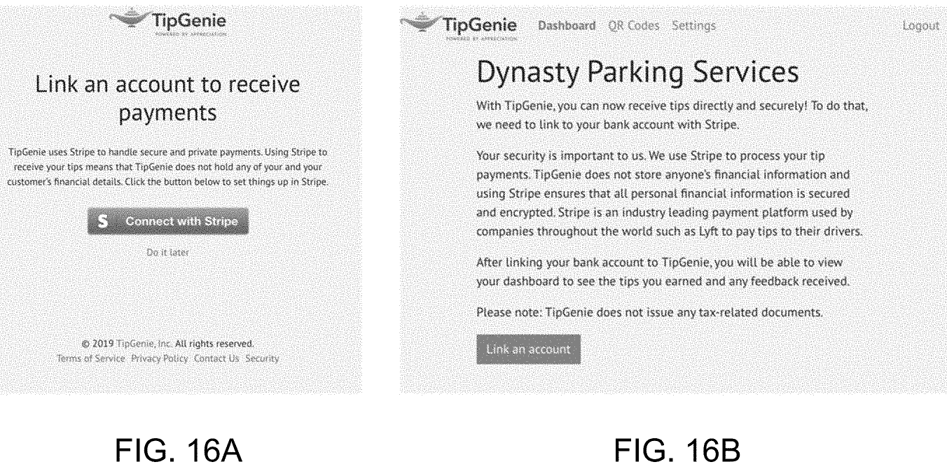

FIGS. 16A and 16B show employee interfaces through which an employee can manage their account as part of a closed loop multi-party tipping system. FIG. 16A shows an employee interface through which an employee can link their account to a third-party digital payment system. FIG. 16B shows an employee interface through which an employee can link an employee bank account to which the third-party digital payment system can deposit the employee's tips. In another embodiment, an employee can link their account directly to an employee bank account, where the tips are deposited directly into the employee bank account without using a third-party digital payment system. In another embodiment, tips can be sent directly to payroll of an employer of an employee, where the tips are processed and included as part of the pay of the employee.

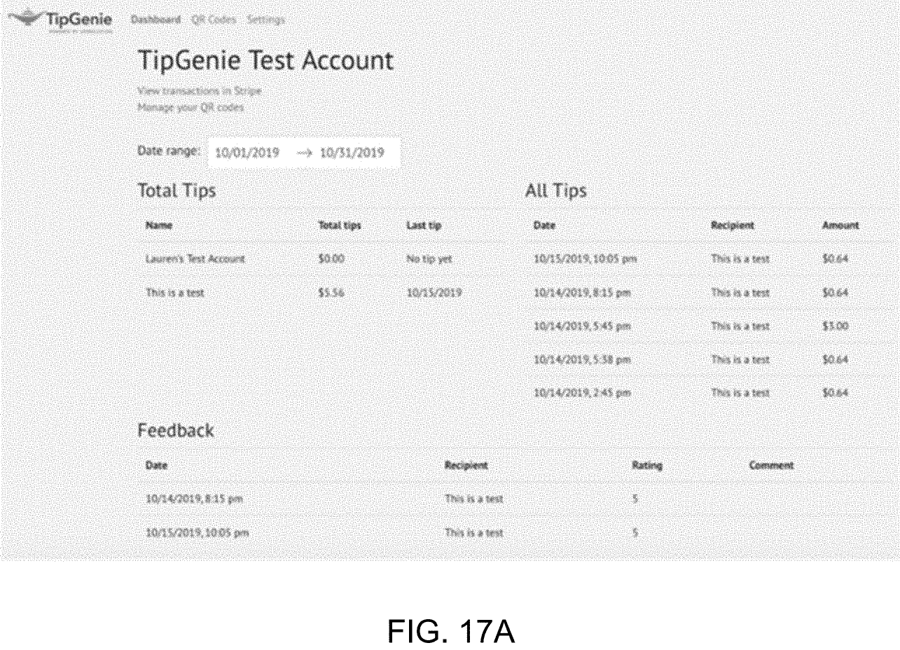

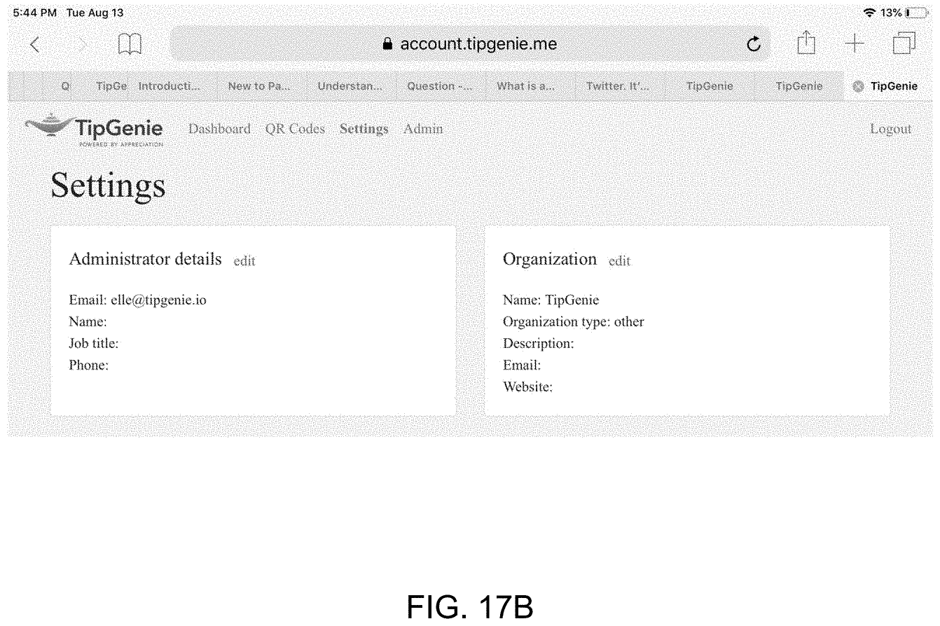

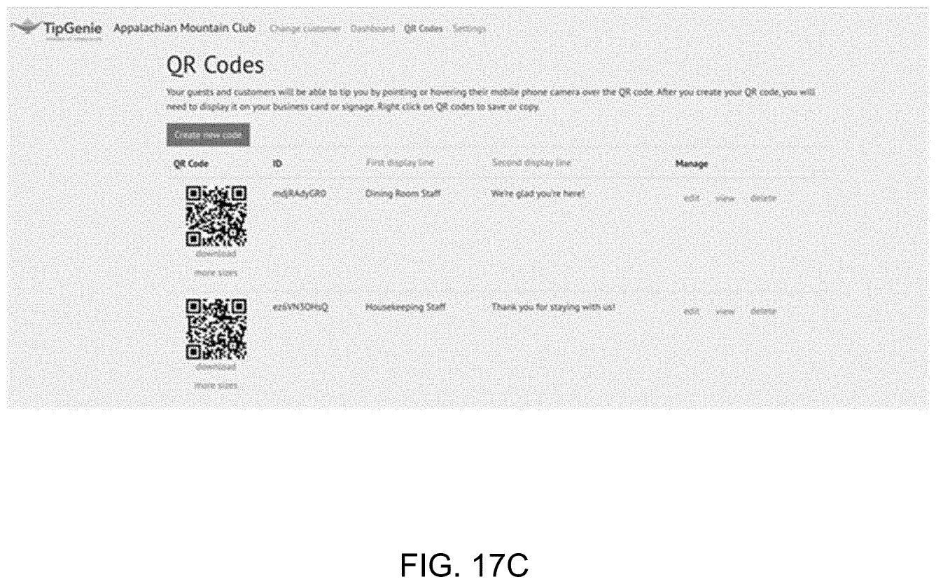

FIGS. 17A-C show various employer interfaces through which an employer can manage its account as part of a closed loop multi-party system. FIG. 17A shows an employer dashboard that provides an overview of key metrics (e.g., total tips received, feedback received). In an embodiment, an employer can specify a date range for which the metrics are displayed. FIG. 17B shows an interface through which an employer can enter administrator and organization details. FIG. 17C shows an interface through which an employer can manage QR codes.

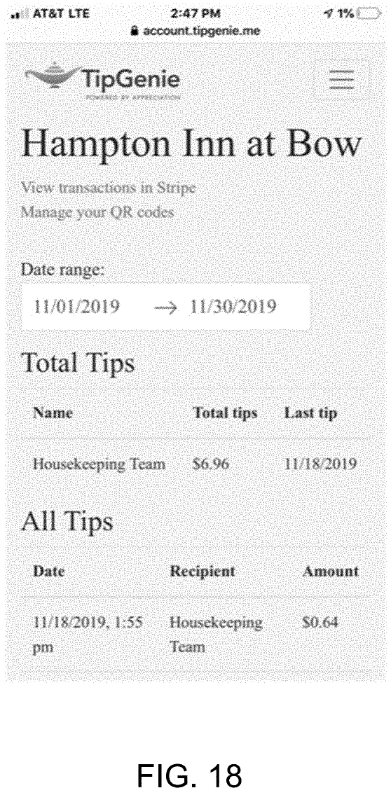

FIG. 18 shows a mobile employer interface through which an employer can manage its account as part of a closed loop multi-party system. FIG. 18 shows the employer dashboard, and the employer can access other functions of the interface (e.g., settings, QR code management) using the menu button on the upper right of the screen.

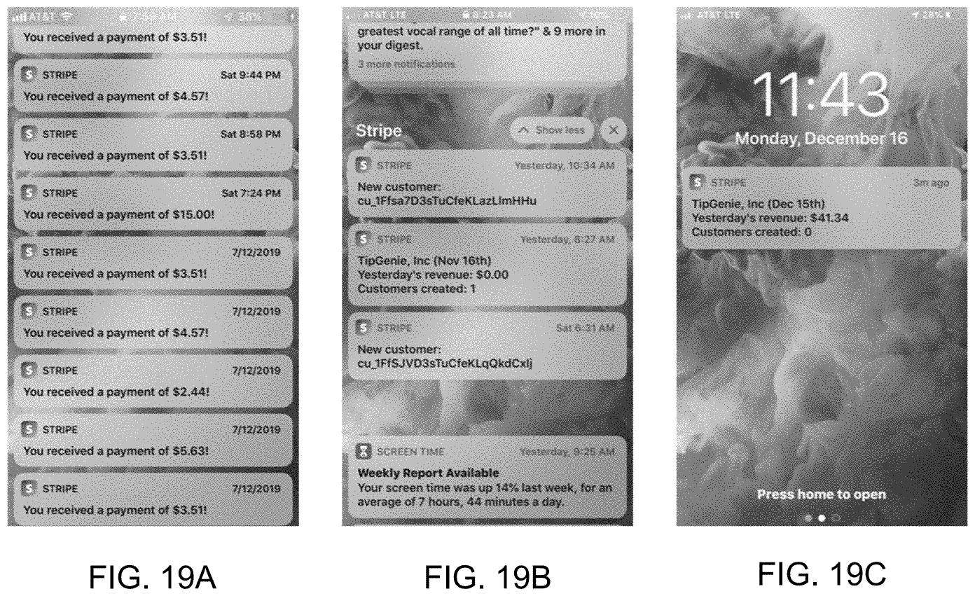

FIGS. 19A-C show example notifications in an embodiment where the closed loop multi-party system is linked with a third-party digital payment system that processes payments. FIG. 19A shows a listing of payments received, FIG. 19B shows a listing of new customers, and FIG. 19C shows a daily summary of revenue and new customers.

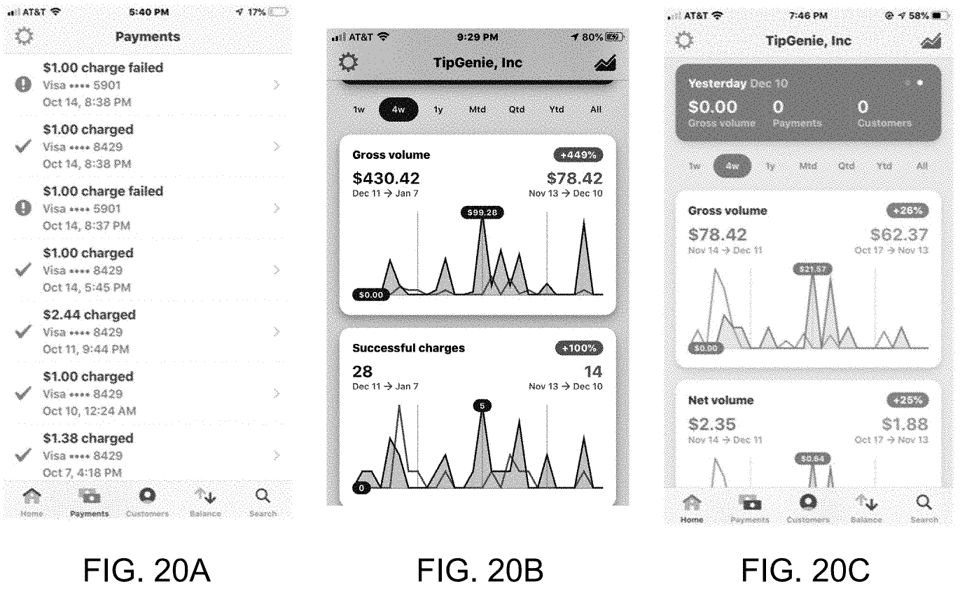

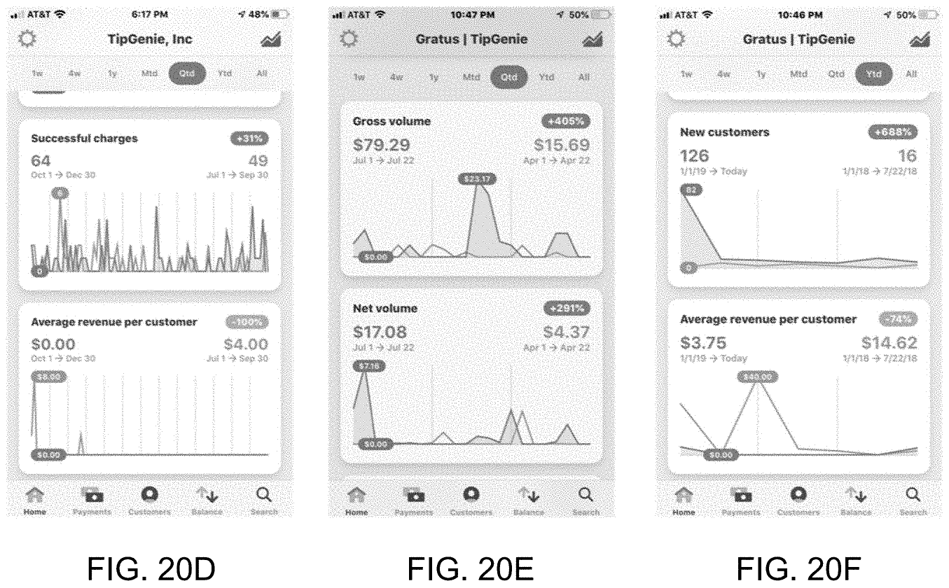

FIGS. 20A-F show various interfaces that display analytics data generated as part of a closed loop multi-party system. FIG. 20A shows a listing of payments received. FIGS. 20B and 20C show metrics for a 4 week period, and FIGS. 20D and 20E show metrics for quarter to date. FIG. 20F shows metrics for year to date. In an embodiment, the employer can customize the interfaces to show various types of metrics and/or can specify a particular date range.

These and other examples provided in this paper are intended to illustrate but not necessarily to limit the described implementation. As used herein, the term “implementation” means an implementation that serves to illustrate by way of example but not limitation. The techniques described in the preceding text and figures can be mixed and matched as circumstances demand to produce alternative implementations.

1. A method comprising:
developing one or more Quick Response (QR) codes for an organization, the QR codes being associated with an organizationally unique identifier (UID);
onboarding, in association with at least one of the one or more QR codes, a person, location, or device associated with the organization and having a UID;
incorporating the QR codes into a set of physical QR code displays;
obtaining an event record in association with a QR code scan instance;
using operational intelligence to associate event parameter values of the event record with the UID of the person, location, or device;
attributing QR code scan instance parameter values associated with the QR code scan instance in accordance with organizational rules;
using the event record to perform operational analytics.

2. The method of claim 1, wherein the operational analytics comprise one or more of transactional, predictive, and performance analytics.

3. The method of claim 1, further comprising providing a map of activity for certain types of events.

4. The method of claim 1, wherein the QR code scan instance parameter values comprise one or more of a monetary amount, feedback, responses to survey questions, a rating of a person associated with the organization, and a rating of the organization.

5. The method of claim 1, wherein the at least one of the one or more QR codes is associated with a person and the QR code scan instance parameter values include a monetary amount, the method further comprising:
transferring the monetary amount to a bank account associated with the person; or
notifying a payroll system of the organization of the monetary amount and disbursing the monetary amount to the person through the payroll system.

6. The method of claim 1, wherein the UID of the person, location, or device is associated with a group or division of the organization, and the QR code scan instance parameter values associated with the QR code scan instance are attributed to the group or division.

7. The method of claim 1, wherein the at least one of the one or more QR codes is associated with a person, the method further comprising determining a location of the person through one or more of facial recognition, geolocation using a device of the person, and radio frequency identification (RFID).

8. The method of claim 1, wherein the set of physical QR code displays comprises one or more of a nametag of a person, a sign associated with a particular location, a sign deployed at a particular location, and a sticker affixed to a device.

9. The method of claim 1, wherein the QR code scan instance directs a customer associated with the QR code scan instance to a web-based interface, the code scan instance parameter values being input by the customer using the web-based interface.

10. The method of claim 1, further comprising providing one or more awards to a customer associated with the QR code scan instance.

11. A system comprising:
an organizationally unique Quick Response (QR) code generation engine configured to develop one or more Quick Response (QR) codes for an organization, the QR codes being associated with an organizationally unique identifier (UID);
a policy compliant onboarding engine configured to onboard, in association with at least one of the one or more QR codes, a person, location, or device associated with the organization and having a UID;
a QR code physical display set incorporation engine configured to incorporate the QR codes into a set of physical QR code displays;
a QR code scan instance event capture engine configured to obtain an event record in association with a QR code scan instance;
a QR code scan instance parameter value attribution engine configured to:
use operational intelligence to associate event parameter values of the event record with the UID of the person, location, or device;
attribute QR code scan instance parameter values associated with the QR code scan instance in accordance with organizational rules;
a QR code scan instance parameter operational analytics engine configured to use the event record to perform operational analytics.

12. The system of claim 11, wherein the operational analytics comprise one or more of transactional, predictive, and performance analytics.

13. The system of claim 11, wherein the QR code scan instance parameter operational analytics engine is configured to provide a map of activity for certain types of events.

14. The system of claim 11, wherein the QR code scan instance parameter values comprise one or more of a monetary amount, feedback, responses to survey questions, a rating of a person associated with the organization, and a rating of the organization.

15. The system of claim 11, wherein the at least one of the one or more QR codes is associated with a person and the QR code scan instance parameter values include a monetary amount, the QR code scan instance parameter value attribution engine being configured to:
transfer the monetary amount to a bank account associated with the person; or
notify a payroll system of the organization of the monetary amount and disburse the monetary amount to the person through the payroll system.

16. The system of claim 11, wherein the UID of the person, location, or device is associated with a group or division of the organization, the QR code scan instance parameter value attribution engine being configured to attribute the QR code scan instance parameter values associated with the QR code scan instance to the group or division.

17. The system of claim 11, wherein the at least one of the one or more QR codes is associated with a person, the QR code scan instance event capture engine being configured to determine a location of the person through one or more of facial recognition, geolocation using a device of the person, and radio frequency identification (RFID).

18. The system of claim 11, wherein the set of physical QR code displays comprises one or more of a nametag of a person, a sign associated with a particular location, a sign deployed at a particular location, and a sticker affixed to a device.

19. The system of claim 11, wherein the QR code scan instance event capture engine is configured to direct a customer associated with the QR code scan instance to a web-based interface, the code scan instance parameter values being input by the customer using the web-based interface.

20. A system comprising:
means for developing one or more Quick Response (QR) codes for an organization, the QR codes being associated with an organizationally unique identifier (UID);
means for onboarding, in association with at least one of the one or more QR codes, a person, location, or device associated with the organization and having a UID;
means for incorporating the QR codes into a set of physical QR code displays;
means for obtaining an event record in association with a QR code scan instance;
using operational intelligence to associate event parameter values of the event record with the UID of the person, location, or device;
means for attributing QR code scan instance parameter values associated with the QR code scan instance in accordance with organizational rules;
means for using the event record to perform operational analytics.
